(19) United States
(12) Patent Application Publication
(10) Pub. No.: US 2026/0081489 A1
(43) Pub. Date: Mar. 19, 2026

(54) ELECTRIC MACHINE WITH ROTOR MAGNET TABS

(71) Applicant: BorgWarner Inc., Auburn Hills, MI (US)

(72) Inventors: Kirk Neet, Noblesville, IN (US); Matthew Ryan Conner, Franklin, IN (US)

(21) Appl. No.: 19/330,607

(22) Filed: Sep. 16, 2025

Related U.S. Application Data
(60) Provisional application No. 63/695,988, filed on Sep. 18, 2024.

(51) Int. Cl. H02K 1/276; H02K 15/027; H02K 15/035; H02K 15/40

(52) U.S. Cl. CPC H02K 1/276; H02K 15/027; H02K 15/035; H02K 15/40

(57) ABSTRACT

An electric machine includes a stator having a plurality of windings and a rotor positioned within the stator. The rotor includes a lamination stack formed from a plurality of lamination sheets with a plurality of slots formed in the lamination stack. The rotor further includes a plurality of magnets arranged in the plurality of slots. At least one of the plurality of lamination sheets includes a tab extending into an associated one of the plurality of slots, the tab including a bent distal tip defining a distal curved surface and a bent proximal joint defining a proximal curved surface, wherein the distal curved surface engages one of the plurality of magnets positioned in the associated one of the plurality of slots.

### CROSS-REFERENCE TO RELATED APPLICATIONS

The present application claims priority from United States provisional patent application number 63/695,988, filed Sep. 18, 2024, the entire contents of which are incorporated by reference herein.

### FIELD

The present disclosure relates to the field of electric machines, and more particularly, electric motors for electric vehicles.

### BACKGROUND

Interior permanent magnet electric machines have been widely used as driving and generating machines for various applications, including electric and hybrid-electric vehicles. Internal permanent magnet (IPM) electric machines have magnets built into the interior of the rotor. Typically, each magnetic pole on the rotor is created by putting permanent magnet (PM) material into one or more slots formed in the laminated stack of the rotor. Although slots are formed for the magnets, the slots are typically not completely filled with magnetic material. In particular, the slots are typically longer than the magnets, and the magnets are placed in the center portion of each slot. This results in a slot with a magnet in the center and voids at two opposite ends of the slot.

There are several reasons for shaping slots longer than the magnets such that voids are provided at the ends of the slots. Examples of such reasons include issues related to performance of the electric machine and manufacturing issues. These issues are discussed in U.S. Pat. No. 7,851,958 , issued Dec. 14, 2010, the entire contents of which are incorporated by reference herein.

In electric machines wherein the magnets that are shorter than the slots, features must be utilized to maintain the proper position of the magnets within the slots. Without such stabilizing features, the magnets tend to slide between the voids at the ends of the slots. Unfortunately, the use of stabilizing features in an IPM machine can affect the magnetic fields within the machine. If care is not taken in the design of the IPM machine, situations can occur where the magnetic fields can demagnetize the permanent magnets over time. Irreversible demagnetization of the permanent magnets can lead to decreased performance of the electric machine.

Accordingly, it would be desirable to provide an IPM electric machine with stabilizing features for magnets within the electric machine. It would also be desirable if such stabilizing features did not adversely affect the magnetic fields and related magnetic properties in the electric machine which might lead to demagnetization of the machine's permanent magnets. Furthermore, it would be desirable if such stabilizing features could be provided at a relatively small increase in manufacturing costs.

In at least some prior art electric machines, straight tabs are provided in the slots of the rotor in order to apply pressure to the magnets against the outer wall of the magnet slot. However, as illustrated in FIG. 7, when magnets are inserted into slots with tabs, the straight tabs tend to scrap off the protective coating on the magnets. This damage to the magnets may result in diminished magnet performance over time.

In view of the foregoing, it would be advantageous to provide an electric machine that is configured to retain magnets in the magnet slots on the rotor but avoids the expense of epoxy in the slots. It would also be advantageous to provide a method of making such an electric machine that did not result in scraping of the protective coating on the magnets.

### SUMMARY

An electric motor and associated method of making an electric motor is described herein. The method of making the electric motor includes pre-bending a tip of a tab that extends into the rotor slot such that the portion of the tab which contacts the magnet is not a sharp edge. No epoxy is required to retain the magnet in the slot. Therefore, the problem of epoxy cost with some prior art magnets is solved by eliminating the epoxy. Also, the problem of magnet coating damage (i.e., scraping) is solved by eliminating the tab's sharp edge contacting the magnet.

In at least one embodiment, an electric machine includes a stator having a plurality of windings and a rotor positioned within the stator. The rotor includes a lamination stack formed from a plurality of lamination sheets with a plurality of slots formed in the lamination stack. The rotor further includes a plurality of magnets arranged in the plurality of slots. At least one of the plurality of lamination sheets includes a tab extending into an associated one of the plurality of slots, the tab including a bent distal tip defining a distal curved surface and a bent proximal joint defining a proximal curved surface, wherein the distal curved surface engages one of the plurality of magnets positioned in the associated one of the plurality of slots.

In another embodiment of the disclosure, a rotor for an electric machine includes a plurality of magnets and a lamination stack formed from a plurality of lamination sheets. A plurality of slots are formed in the lamination stack and at least one magnet of the plurality magnets is positioned in an associated slot of the plurality of slots. At least one lamination sheet of the plurality of lamination sheets includes a tab extending into the associated slot, the tab including a distal curved surface and a proximal curved surface. The distal curved surface engages the magnet within the associated slot, and the proximal curved surface is separated from the magnet within the associated slot.

In yet another embodiment, a method is disclosed for securing magnets within an electric machine. The method includes forming a core of the electric machine comprising a lamination stack formed of a plurality of lamination sheets, the lamination stack defining a plurality of slots configured to receive a plurality of magnets, wherein at least one of the plurality of lamination sheets includes at least one tab extending into an associated slot of the plurality of slots. The method further include pre-bending the tab prior to insertion of a magnet into the associated slot. Thereafter, the method includes inserting a magnet into the associated slot, wherein the tab is further bent during insertion of the magnet into the associated slot.

The above described features and advantages, as well as others, will become more readily apparent to those of ordinary skill in the art by reference to the following detailed description and accompanying drawings. While it would be desirable to provide an electric machine that provides one or more of these or other advantageous features as may be apparent to those reviewing this disclosure, the teachings disclosed herein extend to those embodiments which fall within the scope of the appended claims, regardless of whether they include or accomplish one or more of the advantages or features mentioned herein.

### BRIEF DESCRIPTION OF THE DRAWINGS

FIG. 1 shows a partial cross-sectional view of a rotor and stator of an electric machine through a radial plane, wherein a lamination stack of the rotor includes magnets positioned in magnet slots;

FIG. 2 illustrates a magnet being inserted into one of the magnet slots of FIG. 1;

FIGS. 3A-3C show a lamination of the lamination stack of FIG. 1 wherein a straight tab of the lamination is bent in association with a series of steps for magnet insertion; and

FIGS. 4A-4D show the lamination stack of FIG. 1 during a process of pre-bending a tip of a straight tab and then further bending the pre-bent tab during magnet insertion;

FIG. 5 shows a succession of straight tabs of the lamination stack prior to bending during the process of FIGS. 4A-4D;

FIGS. 6A-6C show an insert tooling in various steps of pre-bending the straight tabs and then retraction from the magnet slots; and

FIG. 7 shows photos of damaged prior art magnets resulting from engagement with a straight tab that does not include the pre-bending process for the tab.

### DESCRIPTION

In the following description, an electric machine is disclosed with a rotor including magnet pockets having tabs arranged therein. The rotor is manufactured by preparing a lamination stack wherein straight tabs are stamped into special laminations that are periodically arranged on the lamination stack. The tabs are pre-bent near their tips prior to magnet insertion. When a magnet is inserted into the magnet pocket, the tabs are further bent without damaging the magnet. The bent tabs hold the magnet to the outer edge of the magnet pocket.

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Further, irrespective of whether it is explicitly described, one of ordinary skill in the art will readily appreciate that each of the particular features, structures, or characteristics of the given embodiments may be utilized in connection or combination with those of any other embodiment discussed herein.

Additionally, it will be noted that the following description of embodiments of an electric machine with rotor magnet tabs makes use of relative terms that may be dependent on an orientation of the structure at a given time (e.g., during manufacture or use of the machine in a vehicle). Accordingly, it will be recognized that many terms of orientation and position as used herein are defined with reference to what may be shown in the drawings and/or other common positions. While efforts have been made herein to reference portions of a structure with respect to non-changing features (e.g., “axial,” “radial” and “circumferential” directions and related positions of the stator), it will be recognized that other terms are relative terms that depend on the position of the structure (e.g., “vertical,” “horizontal,” “upward,” “downward,” “top,” “bottom,” etc.).

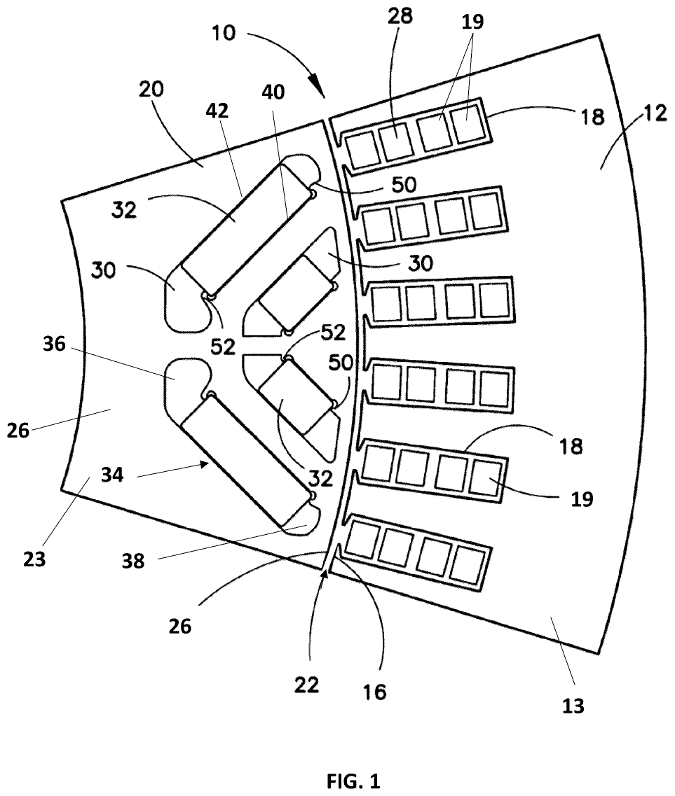

With reference to FIG. 1, a partial cross-sectional view of an electric machine is shown. The electric machine 10 comprises a stator 12 and a rotor 20 opposing the stator 12. A plurality of slots 30 are formed in the rotor 20, each of the plurality of slots are configured to hold a permanent magnet 32. It will be appreciated by those of ordinary skill in the art that FIG. 1 shows only about 45° of the rotor and stator arrangement for the sake of simplicity, but the rotor and stator arrangement actually extends 360° to form a complete circular rotor and stator arrangement for the electric machine.

The stator 12 includes a main body portion provided by of a stack of lamination sheets 13 comprised of magnetic-permeable material, such as silicon steel or a ferromagnetic material. The partial cross-sectional view of FIG. 1 illustrates the general disc shape for one lamination of the stator lamination stack 13. The stator itself is also generally disc shaped and includes a circular or polygonal outer perimeter 14 and a circular inner perimeter 16. An inner cavity configured to receive the rotor 20 is formed within the inner perimeter 16 of the stator 12. Winding slots 18 are formed in the stator 12. Openings to the winding slots are provided at the inner perimeter 16 of the stator. Conductors 19 are placed in the winding slots 18 to form armature windings for the electric machine on the stator 12.

The rotor 20 also includes a main body portion provided by a stack 23 of lamination sheets 21 comprised of magnetic-permeable material, such as silicon steel or a ferromagnetic material. The partial cross-sectional view of FIG. 1 illustrates the general disc shape for one lamination sheet 21 (which may also be referred to herein as simply a “lamination”) of the rotor lamination stack 23. The laminations 21 are all generally the same size and shape, but at least one lamination of the lamination stack includes a magnet retaining tab 60, as explained in further detail below. When the laminations 21 are stacked on top of one another, the lamination stack 23 is formed, which provides a core for the rotor 20. The general shape of the rotor 20 is defined by the lamination stack 23 and includes a circular outer perimeter 26. The rotor is designed and dimensioned to fit within in the inner cavity of the stator 12 such that the circular outer perimeter 26 of the rotor 20 is positioned opposite the circular inner perimeter 16 of the stator 12. A small air gap 22 separates the stator 12 from the rotor 20, and the rotor 20 is configured to rotate relative to the stator 12.

The rotor 20 includes a plurality of magnet pockets 30 configured to retain permanent magnets 32 (which magnet pockets are also referred to herein as “magnet slots” or simply “slots”). Each magnet slot 30 in the rotor 20 includes a central magnet retaining portion 34 positioned between two opposing end portions 36, 38. The magnet retaining portion 34 of each slot 30 is designed to retain a magnet 32. As explained in further detail below, at least one magnet retention tab 60 extends into the central magnet retaining portion 34 to assist in retaining the magnet in the slot 30. The magnets 32 in the embodiment of FIG. 1 are generally rectangular in shape, and thus the magnet retaining portion 34 associated with each magnet 32 is similarly rectangular in shape. The magnet retaining portion 34 is also slightly larger than the magnet 32 such that the magnet 32 may be inserted into the associated magnet retaining portion 34 of the slot 30 during assembly of the rotor 20. The opposing end portions 36, 38 of each slot 30 are non-ferromagnetic portions. These non-ferromagnetic portions are designed to remain empty, providing voids in the opposing end portions 36, 38. However, in at least some embodiments, the opposing end portions 36, 38 may be filled by non-magnetic-permeable materials, such as nylon. In each case, the end portions 36, 38 provide two non-ferromagnetic portions with the magnet retaining portion 34 of the slot positioned between the non-ferromagnetic portions 36, 38.

In at least one embodiment, such as that shown in FIG. 1, the slots 30 in the rotor 20 are configured in a nested V-shaped slot arrangement comprised of two V-shaped slot arrangements with a first V-shaped slot arrangement positioned within a second V-shaped slot arrangement. Each slot 30 provides one of two opposite legs of one V-shape arrangement. Each V-shaped slot arrangement includes a mouth end that opens toward the stator 12 and a vertex end (or tip end) that is closer to a center of the rotor 20 than the mouth end. Each slot 30 that forms a leg of one of the V-shaped slot arrangement includes two elongated sides. The two elongated sides of each slot include an inner-V side 40 (also referred to herein as a stator side 40) and an outer-V side 42 (also referred to herein as an opposing side 42). Accordingly, the stator side 40 of the slot 30 generally opposes the outer periphery 26 of the rotor, and the opposite side 42 of the slot 30 generally opposes an inner periphery of the rotor (or center axis defined by the rotor). In the embodiment of FIG. 1, the slots 30 are completely separated at the tip end of the V-shaped slot arrangement, such that two separate slots form the V-shaped slot arrangement. In this embodiment, the elongated sides of different slots do not connect together. However, in other embodiments, the slots 30 of each V-shaped slot arrangement may merge together.

In the embodiment disclosed herein, magnet locators 50, 52 are also arranged at the ends of the slots 30. The portion of the slot between the magnet locators 50, 52 defines the central magnet retaining portion 34; the void portions (i.e., the non-magnetic-permeable portions) that border the central magnet retaining portions define the end portions 36, 38 of the slot. The magnet locators 50, 52 are spaced in the slot such that they fit up against opposing shorter ends of the magnet 32 to be placed in the slot. Accordingly, with the magnet locators 50, 52, the slot is configured such that the shape of the slot helps to retain the magnet in its proper position once it is inserted in the slot.

As noted previously, the magnets 32 are generally rectangular in shape and are designed to fit within the central magnet retaining portion 34. Accordingly, each rectangular magnet 30 includes two elongated sides which abut or are in close proximity to the elongated sides 40, 42 of the slot 30. The magnet 32 also includes two shorter sides that abut or are in close proximity to the magnet locators 50, 52 at the boundary of the central portion 34. Thus, all four sides of the rectangular magnet abut or are in close proximity to a solid surface, and this arrangement helps secures the magnet 32 in place within the slot 30.

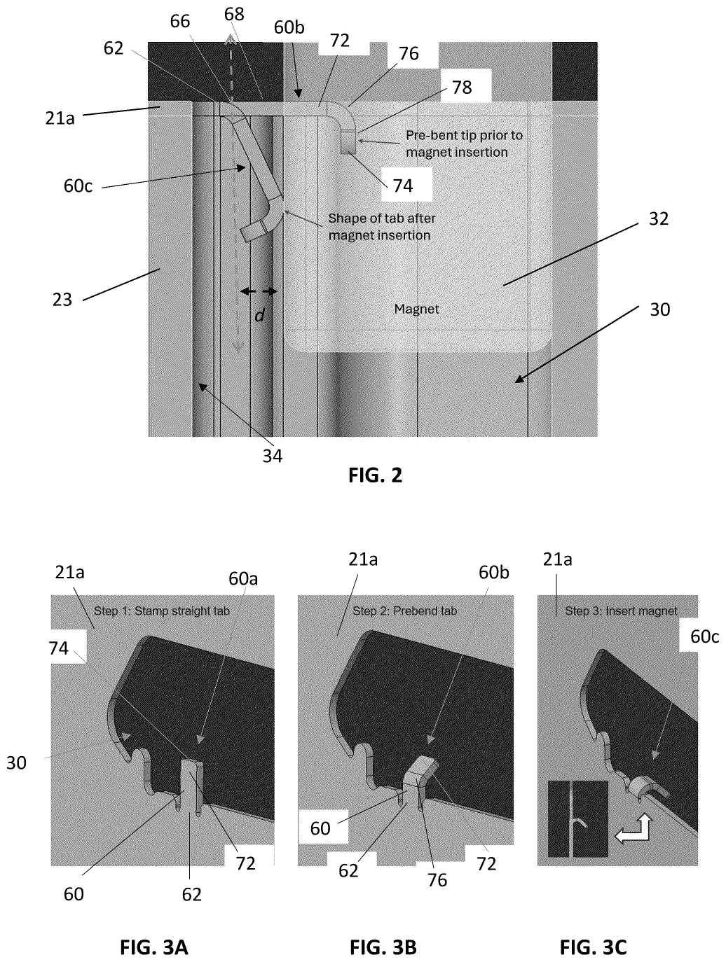

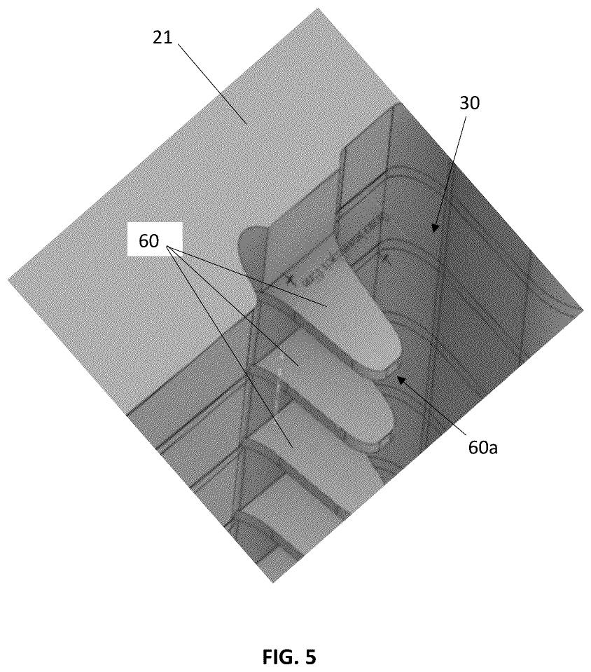

With reference now to FIGS. 2-3C at least one lamination 21a of the plurality of laminations 21 of the lamination stack 23 includes a tab 60 that extends into the magnet retaining portion 34 of an associated magnet slot 30. The tab 60 is integrally formed with the other features of the lamination 21a when a sheet of magnetic-permeable material is stamped (or otherwise made) in order to form the lamination 21a. It will be recognized that each lamination 21 is a monolithic sheet of material that provides all components of the sheet including the slots 30 formed therein and any associated tabs 60. Each tab 60 is a generally narrow and flat finger-like member that projects into the slot 30 and is defined by a thickness that is the same as or substantially the same as the remainder of the lamination sheet 21a. While a single lamination 21a with a tab 60 that extends into the slot 30 is illustrated in FIGS. 2-3C, it will be recognized that several laminations 21a with tabs 60 are anticipated in different embodiments of the rotor 20. For example, in at least one embodiment, at least every fifth lamination is a lamination 21a with tabs 60 (e.g., each lamination 21a with tabs 60 is stacked on top of a series of seven to ten additional laminations with no tabs). The tabs 60 may be arranged in columns within the slots, similar to the column of tabs 60 shown in FIG. 5.

With continued reference to FIGS. 2-3B, the tabs 60 of the laminations 21a undergo a formation process during manufacture of the rotor 20 from an initial stamped condition (shown in FIG. 3A) to a final completed condition (shown in FIG. 3C). FIG. 3A shows the lamination sheet 21a with the tab 60 in a pre-assembly/initial condition 60a following stamping of the lamination sheet. In this initial condition 60a, the tab 60 is provided as a straight, narrow, flat finger structure that extends directly into the slot 30, and the entire tab 60 is parallel to the rest of the lamination sheet 21a. The tab 60 includes a proximal end 62 and a distal end 72. The proximal end 62 is near a perimeter edge of the slot 30. The distal end 72 projects outward in a peninsula-like manner into the slot 30 and does not engage any components within the slot 30 when in the initial condition 60a. Accordingly, the distal end 72 of the tab may be considered a “free edge” in the initial condition 60a. The distal perimeter edge 74 of the tab 60 is a relatively sharp edge formed from stamping of the lamination (and may also be referred to herein as a “stamped edge”) or other manufacturing process. In order to protect the magnet 32 from this sharp distal perimeter edge 74, further manipulation of the tab 60 is performed during the manufacturing process, as explained in further detail below.

As shown in FIG. 3B, the distal end 72 of the tab 60 is pre-bent prior to installation of the magnet 32 in the slot. In this pre-bent/intermediate condition 60b, the distal end 72 is generally bent about 90° (e.g., between 85° and 95°) relative to the proximal end 62. Following the pre-bend process of FIG. 3B, the tab 60 includes a distal end 72 with a first/distal curved surface 76. As a result, the end tip 78 of the tab 60 defines a flat surface that is generally perpendicular to the proximal end 62 (e.g., generally vertical) and therefore parallel to the perimeter walls of the slot 30. The arrangement of the surface of the tip 78 is best illustrated in FIG. 2. As shown in FIG. 2, the perimeter of the tab 60 at the stamped edge 74 is generally perpendicular to the slot walls when the tab 60 is in the pre-bent configuration 60b. It words, the distal end tip 78 that is generally perpendicular to the proximal end 62. Accordingly, when in the pre-bent condition 60b (shown in FIGS. 2 and 3B), the sharp stamped edge 74 of the tab 60 is diverted away from the outwardly exposed position of the stamped edge 74 when in the initial condition 60a (shown in FIG. 3A).

As shown in FIG. 3C, when the magnet 32 is inserted into the slot 30 during manufacture of the rotor 20, the magnet further bends the tab 60 closer to the proximal end 62 of the tab 60. In this assembled/final condition 60c, an additional curvature is formed in the tab 60 at a bent proximal joint positioned closer to the proximal end 62 of the tab 60 near the perimeter wall of the slot 30. This additional curvature is best illustrated in FIG. 2 by proximal curved surface 66 formed inwardly from (i.e., on a proximal side of) the distal curved surface 76 and the distal perimeter edge 74. While FIG. 2 shows a length of flat section 68 on the tab 60 between the proximal curved surface 66 and the distal curved surface 76, it will be recognized that in some embodiments, the proximal curved surface 66 may be so close to the distal curve surface 76 that the proximal curved surface 66 is integral with the distal curved surface 76 (i.e., in other words, the proximal curved surface 66 bleeds into the distal curved surface 76 with no flat section 68 therebetween). As also shown in FIG. 2, once the magnet 32 is inserted into the slot 30, the distal curved surface 76 engages the magnet 32 and the proximal curved surface 66 is separated from the magnet by a short distance d.

Once the magnet 32 is fully inserted into the slot 30, the distal curved surfaces 76 of the tabs 60 press against one side of the magnet 32 and force another side of the magnet into close engagement with an edge of the slot. This results in a strong friction-fit for the magnet 60 within the slot 30. In at least some embodiments, no additional material is used to secure the magnets in the slots. In other embodiments, epoxy or other adhesives may be used to further secure the magnet 32 in the slot.

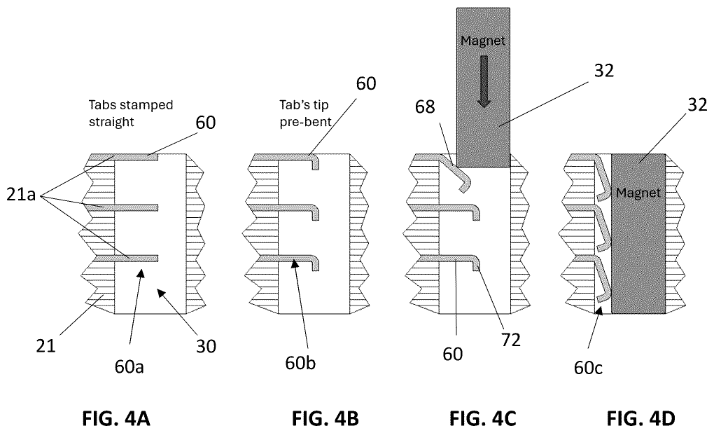

With reference now to FIGS. 4A-4D, a method of making a rotor 20 for an electric machine 10 is illustrated. FIG. 4A shows one slot 30 of a lamination stack with a plurality of laminations 21a including tabs 60 (also referred to herein as “special laminations”). Each special lamination 21a is positioned on top of a series of seven regular laminations 21 that do not include tabs 60. As shown in FIG. 4A, the lamination stack is formed with the special laminations in the “initial condition” discussed above, wherein each tab is flat and extends in a radial direction into the associated slot 30. FIG. 5 shows an enlarged perspective view looking downward into a magnet slot 30 with a column of tabs 60 positioned in the slot 30. As shown in FIG. 5, each of the tabs 60 is in the initial condition with each tab in a flat condition and projecting outward into the slot 30.

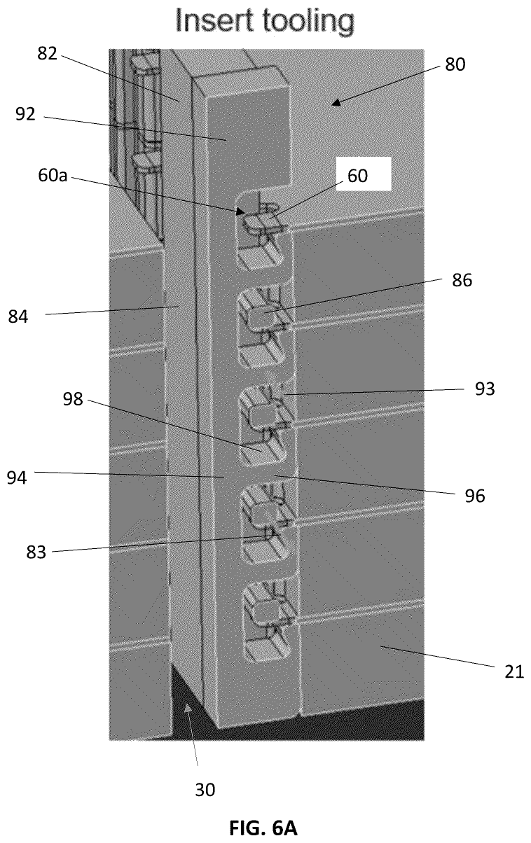

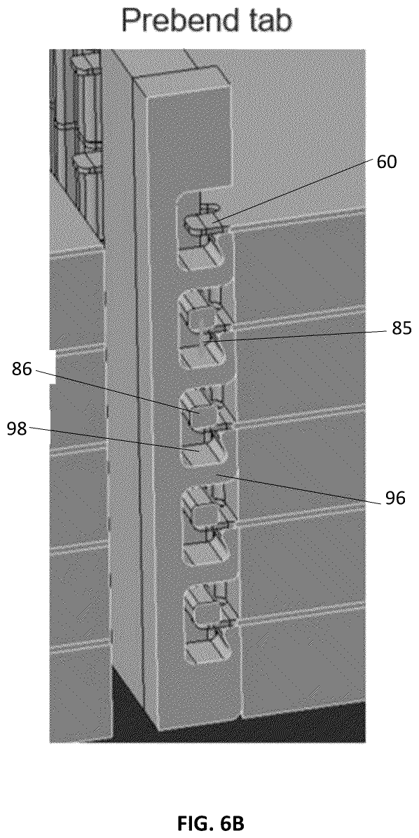

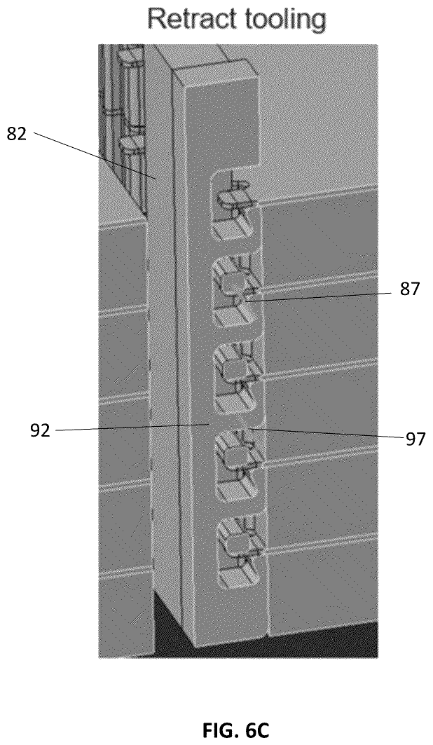

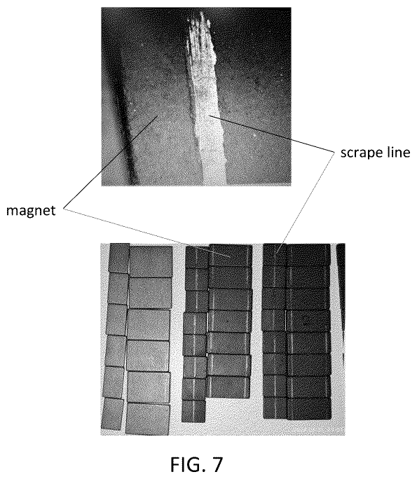

After the lamination stack is formed with the tabs 60 in the initial condition, the tabs 60 are bent to the “pre-bent condition” discussed above, and as shown in FIG. 4B. In at least one embodiment, the tabs 60 are bent into the pre-bent condition using insert tooling configured to bend the tabs 60 from the initial condition to the pre-bent condition. An exemplary insertion tool 80 configured to perform the pre-bending process is shown in FIGS. 6A-6C. The insertion tool 80 (which may also be referred to as a “forming tool”) is a two-part component that includes a bending block 82 that is freely moveable relative to a die block 92. The bending block 82 is an elongated post-like structure configured to extend into the magnet slot 30 between two columns of tabs 60 positioned within the slot. The bending block 82 includes an elongated base portion 84 defined along an axis (e.g., a vertical axis) with a plurality of pegs 86 that extend perpendicularly outward from the base portion 84 (e.g., in the horizontal direction). The elongated base portion 84 has a substantially rectangular cross-section with four generally flat sides. The pegs 86 extend outwardly from one of the flat sides. The number of pegs 86 on the bending block 82 is equal to the number of tabs 60 in a column of tabs within the slot 30. The pegs 86 are periodically spaced apart on the bending block 82 to match the spacing of the tabs 60 within a column of tabs within the slot 30.

The die block 92 of the insertion tool 80 includes an elongated post 94 with a plurality of dies provided by hook-shaped structures 96 extending from the post 94. The elongated post 94 has a substantially rectangular cross-section with three generally flat sides. One of the flat sides of the die block 92 abuts and is configured to slide relative to one of the flat sides of the bending block, as explained in further detail below. Each of the hook-shaped structures 96 extends perpendicularly outward from the post 94 and then curves upward to a position that is parallel to the post. A forming surface 98 is provided along an interior surface of each hook-shaped structure 96. Similar to the pegs 86 of the bending block 82, the number of hook-shaped structures 96 on the die block 92 is equal to the number of tabs 60 in a column of tabs within the slot 30, and the hook-shaped structure 96 are periodically spaced apart on the die block 92 to match the spacing of the tabs 60 within a column of tabs within the slot 30.

In operation of the forming tool 80, the bending block 82 is positioned alongside to the die block 92 with the pegs 86 of the bending block positioned in the interior space defined by the hook-shaped structures 96 of the die block 92. Additionally, a flat surface of the elongated base portion 84 of the bending block 82 is moved into slidable engagement with a flat surface of the post 94 of the die block 92.

In order to pre-bend the tabs 60 in a column of tabs of a given slot, the forming structure 80 is inserted into the associated slot 30 with the bending block 82 on one side of the column of tabs 60 and the die block 92 on the opposite side of the column of tabs 60. Then, as shown in FIG. 6A, the bending block 82 and the die block 92 are moved toward one another and into engagement with one another. Specifically, the bending block 82 is moved in the direction of arrow 83 such that each peg 86 is positioned above an associated tab 60, and the die block 92 is moved in the direction of arrow 93 such that each hook-shaped structure 96 is positioned under an associated tab 60.

After the bending block 82 and the die block 92 are positioned adjacent to one another, the method of bending the tabs 60 from the initial condition to the pre-bent position continues when the bending block 82 is slid downwardly relative to the die block 92, as illustrated by arrow 85 in FIG. 6B. As a result of this movement, the pegs 86 of the bending block 82 force the tabs 60 into engagement with the forming surfaces 98 of the hook-shaped structures 96 on the die block 92. This results in all of the tabs 60 in a column being bent around the curved forming surface 98 and re-configured from the initial condition (as shown in FIG. 4A) to the pre-bent condition (as shown in FIG. 4B).

With all the tabs 60 in a column re-configured to the pre-bent configuration, the method then continues by retracting the forming structure 80 from the column of tabs. This is accomplished by simply moving the bending block 82 away from the die block 92, as noted by the arrows 87 and 97 in FIG. 6C. The insertion tool 80 is then be pulled out of the slot 30. Thereafter, the insertion tool 80 may be repositioned adjacent to another column of tabs for reconfiguration of the tabs from the initial condition to the pre-bent configuration.

Once all of the tabs 60 in a slot are moved to the pre-bent configuration, the method of forming a stator continues by inserting a magnet 32 into the slot 30, as illustrated in FIGS. 4C and 4D (and also illustrated in FIG. 2). As the magnet is first inserted into the slot 30, the bottom edge of the magnet first engages a flat section 68 of the uppermost tab 60 at a location adjacent the distal end 72 of the tab, as shown in FIG. 4C. Then, as the magnet continues to slide into the slot 30, the magnet 32 eventually reaches the distal curved surface 76 and slides along the curved surface. As the magnet 32 slides along the curved surface, the tab 60 is further bent downwardly. In some embodiments, the tabs 60 may be bent downwardly until the distal perimeter edge 74 engages the sidewall of the slot. In other embodiments, the tabs 60 are bent downwardly but do not bend to the extent that they engage the sidewall of the slot. As the magnet 32 is forced further into the slot 30, it engages successive tabs 60, and bends those tabs 60 accordingly, until the magnet 32 is fully inserted into the slot 30 as shown in FIG. 4D. Advantageously, because the magnet never encounters a sharp edge of the tab, no damage is done to the magnet as it slides into the slot 30.

As noted previously, once the magnet 32 is fully inserted into the slot 30, the tabs 60 press against one side of the magnet 32 and force another side of the magnet into close engagement with an edge of the slot. This results in a strong friction-fit for the magnet 60 within the slot 30. In at least some embodiments, multiple columns of tabs 60 are included in each slot 30, and the different columns of tabs act in to force the magnet into a proper position in each slot and retain the magnet within each slot.

It will be recognized that various adaptations and embodiment of the electric machine and associated method are possible. In at least one embodiment, the tabs 60 are stamped straight at the time of stamping the lamination, then pre-bent as single laminations, and then stacked into the lamination stacks. In at least one alternative embodiment, tabs 60 are stamped straight, stacked into laminations stacks (e.g., with approximately every five to fifteen laminations having a tab). The tabs are then pre-bent prior to magnet insertion using with tooling like that shown in FIG. 5.

Although the various embodiments of an electric machine with a rotor magnet tab have been provided herein, it will be appreciated by those of skill in the art that other implementations and adaptations are possible. Furthermore, aspects of the various embodiments described herein may be combined or substituted with aspects from other features to arrive at different embodiments from those described herein. Thus, it will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by any eventually appended claims.

What is claimed is:

1. An electric machine comprising:
a stator including a plurality of windings;
a rotor positioned within the stator, the rotor including:
a lamination stack formed from a plurality of lamination sheets with a plurality of slots formed in the lamination stack; and
a plurality of magnets arranged in the plurality of slots;
wherein at least one of the plurality of lamination sheets includes a tab extending into an associated one of the plurality of slots, the tab including a bent distal tip defining a distal curved surface and a bent proximal joint defining a proximal curved surface, wherein the distal curved surface engages one of the plurality of magnets positioned in the associated one of the plurality of slots.

2. The electric machine of claim 1 wherein the at least one of the plurality of lamination sheets includes at least three lamination sheets with a tab.

3. The electric machine of claim 2 wherein each of the at least three lamination sheets with a tab is separated from another of the at least three lamination sheets with a tab by at least five lamination sheets of the plurality of lamination sheets, wherein the at least five lamination sheets are void of a tab extending into the associated one of the plurality of slots.

4. The electric machine of claim 1 wherein said tab is defined by a same thickness as the at least one of the plurality of lamination sheets.

5. The electric machine of claim 1 wherein an edge of the bent distal tip engages an interior wall of the associated one of the plurality of slots.

6. The electric machine of claim 1 wherein the bent distal tip further includes a stamped perimeter edge.

7. The electric machine of claim 1 wherein the plurality of lamination sheets include a plurality of lamination sheets with a plurality of tabs extending into the associated one of the plurality of slots, wherein the plurality of tabs are arranged in at least one column within the associated one of the plurality of slots.

8. A rotor for an electric machine comprising:
a plurality of magnets; and
a lamination stack formed from a plurality of lamination sheets with a plurality of slots formed in the lamination stack and at least one magnet of the plurality magnets positioned in an associated slot of the plurality of slots, at least one lamination sheet of the plurality of lamination sheets including a tab extending into the associated slot, the tab including a distal curved surface and a proximal curved surface, wherein the distal curved surface engages the magnet within the associated slot and the proximal curved surface is separated from the magnet within the associated slot.

9. The rotor of claim 8 wherein the proximal curved surface is separated from the distal curved surface by a flat section of the tab.

10. The rotor of claim 8 wherein the proximal curved surface is integrally formed with the distal curved surface on the tab.

11. The rotor of claim 8 wherein the tab includes a distal curved surface is provided on a bent distal tip with a stamped perimeter edge, wherein the stamped perimeter edge engages an interior surface of the slot.

12. The rotor of claim 8 wherein the at least one lamination sheet includes at least three lamination sheets with a tab extending into the associated slot.

13. The rotor of claim 12 wherein each of the at least three lamination sheets is separated from another of the at least three lamination sheets by at least five lamination sheets of the plurality of lamination sheets, wherein the at least five lamination sheets are void of a tab extending into the associated one of the plurality of slots.

14. A method of securing magnets within an electric machine comprising:
forming a core of the electric machine comprising a lamination stack formed of a plurality of lamination sheets, the lamination stack defining a plurality of slots configured to receive a plurality of magnets, wherein at least one of the plurality of lamination sheets includes at least one tab extending into an associated slot of the plurality of slots;
pre-bending the tab prior to insertion of a magnet into the associated slot; and
inserting a magnet into the associated slot, wherein the tab is further bent during insertion of the magnet into the associated slot.

15. The method of claim 14 further comprising stamping the plurality of lamination sheets, including the at least one lamination sheet prior to forming the core of the electric machine.

16. The method of claim 14 wherein pre-bending the tab results in a distal curved surface on the tab.

17. The method of claim 16 wherein the magnet engages the distal curved surface of the tab during insertion of the magnet into the slot.

18. The method of claim 17 wherein a proximal curved surface is formed on the tab when the magnet is inserted into the associated slot.

19. The method of claim 14 wherein a forming tool is inserted into the associated slot prior to pre-bending the tab, the forming tool configured to form a distal curved surface on the tab.

20. The method of claim 19 wherein the forming tool includes a bending block with at least one peg configured to engage the tab and a die block with at least one forming surface, wherein the at peg engages one side of the tab and the forming surface engages another side of the tab, wherein the bending block is moved relative to the die block in order to form the distal curved surface on the tab.
